(19) United States
(12) Patent Application Publication
(10) Pub. No.: US 2025/0154050 A1
(43) Pub. Date: May 15, 2025

(54) WATER-REPELLENT STRUCTURE AND WATER-REPELLENT LAYER FORMING COMPOSITION

(71) Applicant: AGC Inc., Tokyo (JP)

(72) Inventors: Ryohei YAMAGUCHI, Tokyo (JP); Shimpei Morita, Tokyo (JP); Satoshi Oki, Tokyo (JP); Tomoya Ushio, Tokyo (JP)

(73) Assignee: AGC Inc., Tokyo (JP)

(21) Appl. No.: 19/021,144

(22) Filed: Jan. 14, 2025

Related U.S. Application Data
(63) Continuation of application No. PCT/JP2023/025352, filed on Jul. 7, 2023.

(30) Foreign Application Priority Data
Jul. 26, 2022 (JP) 2022-118374

(51) Int. Cl. C03C 17/34

(52) U.S. Cl. CPC C03C 17/3405; C03C 2217/76

(57) ABSTRACT

A water-repellent structure includes a substrate, and a water-repellent film formed on a surface of the substrate, in which: the water-repellent film includes a water-repellent layer containing a siloxane bond and one or more type(s) of organic groups bonded to a Si atom and not containing any fluorine atom; a surface of the water-repellent layer is an outermost surface of the water-repellent film; the surface of the water-repellent layer has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region is 3.5 GPa or higher.

### INCORPORATION BY REFERENCE

This application is based upon and claims the benefit of priority from Japanese patent application No. 2022-118374, filed on Jul. 26, 2022 and PCT application No. PCT/JP2023/025352 filed on Jul. 7, 2023, the disclosure of which is incorporated herein in its entirety by reference.

### BACKGROUND

The present disclosure relates to a water-repellent structure and a water-repellent layer forming composition.

Regarding the application of a window glass in a transportation apparatus such as a vehicle, a glass laminate in which a water-repellent film is formed on the outer surface of a glass plate in order to prevent rain, frost, ice, snow and the like from adhering thereto or being deposited thereon and thereby to maintain a clear field of vision has been known.

In the specification of the present application, a structure including a substrate such as a glass plate and a water-repellent film formed on a surface of the substrate is referred to as a “water-repellent structure”.

A water-repellent film includes a water-repellent layer and may include one or more other layers as required. The water-repellent film may include, for example, an underlayer below the water-repellent layer. The surface of the water-repellent layer is exposed. Further, the surface of the water-repellent layer is the outermost surface of the water-repellent film and is a water-repellent surface.

In general, fluorine-based compounds have been used as a material for such a water-repellent layer. However, in recent years, there has been concern about the influence of some fluorine-based compounds, such as a C6 fluorine-based compound, on the environment, and thus a non-fluorine-based composition containing no fluorine-based compound has been developed as a water-repellent layer forming composition.

It is preferred that a water-repellent layer have satisfactory water repellency in its initial state and have satisfactory durability so that satisfactory water repellency can be maintained even after the water-repellent layer is used for a long time. One of the durability characteristics is abrasion resistance.

For example, in its application as a side glass or the like of a vehicle, a window can be opened and closed by lifting up and down a glass laminate including a glass plate and a water-repellent film. In such application, it is preferred that the water-repellent layer have satisfactory abrasion resistance so that the water repellency does not significantly deteriorate even when the surface of the water-repellent layer is repeatedly rubbed.

In Patent Literature 1, the applicant of the present application discloses a non-fluorine-based water-repellent layer forming composition containing one or more type(s) of hydrolyzable silicon compounds, and a water-repellent structure including a water-repellent film including a water-repellent layer formed by using the aforementioned water-repellent layer forming composition (claims 1 and 10, etc.).

The water-repellent layer disclosed in Patent Literature 1 has excellent water repellency and an excellent abrasion resistance.
Patent Literature 1: Japanese Unexamined Patent Application Publication No. 2015-145463

The inventors of the present application have earnestly studied the structure of a micron region on a surface of a water-repellent layer by using an atomic force microscope (AFM), and has invented a non-fluorine-based water-repellent layer having a higher abrasion resistance than that of the water-repellent layer disclosed in Patent Literature 1 and a composition for forming such a non-fluorine-based water-repellent layer.

An object of the present disclosure is to provide a water-repellent structure including a non-fluorine-based water-repellent layer having satisfactory water repellency in the initial state and having satisfactory abrasion resistance so that the water repellency does not significantly deteriorate even when the surface of the water-repellent layer is repeatedly rubbed.

Further, another object of the present disclosure is to provide a water-repellent layer forming composition by which it is possible to form a non-fluorine-based water-repellent layer having satisfactory water repellency in the initial state and having satisfactory abrasion resistance so that the water repellency does not significantly deteriorate even when the surface of the water-repellent layer is repeatedly rubbed.

### SUMMARY

The present disclosure provides a water-repellent structure and a water-repellent layer forming composition described hereinafter.

[1] A water-repellent structure comprising a substrate, and a water-repellent film formed on a surface of the substrate, wherein
the water-repellent film comprises a water-repellent layer containing a siloxane bond and one or more type(s) of organic groups bonded to a Si atom and not containing any fluorine atom,
a surface of the water-repellent layer is an outermost surface of the water-repellent film, and
the surface of the water-repellent layer has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region is 3.5 GPa or higher.

[2] The water-repellent structure according to Item [1], wherein the root mean square inclination value of the surface elastic modulus in the micron region is 35.0 GPa or lower.

[3] The water-repellent structure according to Item [1] or [2], wherein the one or more type(s) of organic groups is selected from the group consisting of an alkyl group and an alkylene group.

[4] The water-repellent structure according to any one of Items [1] to [3], wherein an average elastic modulus in the micron region on the surface of the water-repellent layer is 2.0 to 14.0 GPa.

[5] The water-repellent structure according to any one of Items [1] to [4], wherein in the micron region on the surface of the water-repellent layer, an area ratio of a high-elastic modulus region having an elastic modulus of 6.0 GPa or higher is 1 to 50%, and an area ratio of a low-elastic modulus region having an elastic modulus of 4.0 GPa or lower is 10 to 80%.

[6] The water-repellent structure according to any one of Items [1] to [5], wherein an initial water contact angle on the surface of the water-repellent layer is 90° or larger.

[7] The water-repellent structure according to any one of Items [1] to [6],
wherein the water-repellent layer is a dry-cured substance of a composition containing:
a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and
one or more type(s) of organic solvents;
wherein an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes,
and wherein an HSP value of the one or more type(s) of organic solvents is 10.8 to 12.1, the HSP value being a solubility parameter according to Hansen's definition.

[8] The water-repellent structure according to Item [7], wherein
the hydrolyzable silicone is a compound represented by a below-shown Formula (1),
the hydrolyzable alkylsilane is a compound represented by a below-shown Formula (2),

R¹³—(SiR¹²₂O)ₖ₁—SiR¹²₂—Y¹—Si(R¹¹)₃₋ₙ₁(X¹)ₙ₁ (1)

(in the above-shown formula: R¹³ represents an alkyl group having a carbon atom number of 1 to 30; R¹² each independently represents an alkyl group having a carbon atom number of 3 or smaller; Y¹ represents an alkylene group having a carbon atom number of 2 to 4 or an oxygen atom; R¹¹ each independently represents a monovalent hydrocarbon group; X¹ each independently represents a hydrolyzable group; X¹ may be hydrolyzed into a hydroxyl group; k1 is an integer of 10 to 300; and n1 is an integer of 1 to 3), and

R²²—Si(R²¹)₃₋ₙ₂(X²)ₙ₂ (2)

(in the above-shown formula: R²² represents an alkyl group having a carbon atom number of 1 to 30; R²¹ each independently represents a monovalent hydrocarbon group; X² each independently represents a hydrolyzable group; X² may be hydrolyzed into a hydroxyl group; and n2 is an integer of 1 to 3).

[9] The water-repellent structure according to any one of Items [1] to [8], wherein the water-repellent film includes an underlayer containing a siloxane bond and not containing any fluorine atom below the water-repellent layer.

[10] The water-repellent structure according to Item [9], wherein the underlayer is a dry-cured substance of a composition containing one or more type(s) of hydrolyzable silicon compounds which may be partially hydrolyzed and condensed between the same species or between different species, selected from the group consisting of a compound represented by a below-shown Formula (3) and a compound represented by a below-shown Formula (4),

Si(X³)₄ (3)

(in the above-shown formula: X³ each independently represents a hydrolyzable group; and X³ may be hydrolyzed into a hydroxyl group), and

X⁴₃Si—(CH₂)ₘ—SiX⁴₃ (4)

(in the above-shown formula: X⁴ each independently represents a hydrolyzable group; X⁴ may be hydrolyzed into a hydroxyl group; and m is an integer of 1 to 8).

[11] The water-repellent structure according to any one of Items [1] to [10], wherein the substrate includes a glass plate.

[12] A water-repellent layer forming composition containing:
a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and
one or more type(s) of organic solvents;
wherein an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes,
and wherein an HSP value of the one or more type(s) of organic solvents is 10.8 to 12.1, the HSP value being a solubility parameter according to Hansen's definition.

[13] The water-repellent layer forming composition according to Item [12], wherein
the hydrolyzable silicone is a compound represented by a below-shown Formula (1),
the hydrolyzable alkylsilane is a compound represented by a below-shown Formula (2),

R¹³—(SiR¹²₂O)ₖ₁—SiR¹²₂—Y¹—Si(R¹¹)₃₋ₙ₁(X¹)ₙ₁ (1)

(in the above-shown formula: R¹³ represents an alkyl group having a carbon atom number of 1 to 30; R¹² each independently represents an alkyl group having a carbon atom number of 3 or smaller; Y¹ represents an alkylene group having a carbon atom number of 2 to 4 or an oxygen atom; R¹¹ each independently represents a monovalent hydrocarbon group; X¹ each independently represents a hydrolyzable group; X¹ may be hydrolyzed into a hydroxyl group; k1 is an integer of 10 to 300; and n1 is an integer of 1 to 3), and

R²²—Si(R²¹)₃₋ₙ₂(X²)ₙ₂ (2)

(in the above-shown formula: R²² represents an alkyl group having a carbon atom number of 1 to 30; R²¹ each independently represents a monovalent hydrocarbon group; X² each independently represents a hydrolyzable group; X² may be hydrolyzed into a hydroxyl group; and n2 is an integer of 1 to 3).

[14] The water-repellent layer forming composition according to Item [12] or [13], wherein the surface has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region is 3.5 GPa or higher.

A water-repellent layer included in a water-repellent structure according to the present disclosure has a specific elastic modulus distribution, so that the water-repellent layer can have satisfactory abrasion resistance so that the water repellency does not significantly deteriorate even when the surface of the water-repellent layer is repeatedly rubbed.

According to the present disclosure, it is possible to provide a water-repellent structure including a non-fluorine-based water-repellent layer having satisfactory water repellency in the initial state and having satisfactory abrasion resistance so that the water repellency does not significantly deteriorate even when the surface of the water-repellent layer is repeatedly rubbed.

According to the present disclosure, it is possible to provide a water-repellent layer forming composition of which it is possible to form a non-fluorine-based water-repellent layer having satisfactory water repellency in the initial state and having satisfactory abrasion resistance so that the water repellency does not significantly deteriorate even when the surface of the water-repellent layer is repeatedly rubbed.

The above and other objects, features and advantages of the present disclosure will become more fully understood from the detailed description given hereinbelow and the accompanying drawings.

### BRIEF DESCRIPTION OF DRAWINGS

FIG. 1 is a schematic cross-sectional diagram of a water-repellent structure according to a first embodiment of the present invention;

FIG. 2 is a schematic cross-sectional diagram of a water-repellent structure according to a second embodiment of the present invention;

FIG. 3 is an image showing an elastic modulus in a micron region of a water-repellent layer obtained in Example 3; and

FIG. 4 is an image showing an elastic modulus in a micron region of a water-repellent layer obtained in Example 61.

### DESCRIPTION OF EMBODIMENTS

In the specification of the present application, the “surface” of a planar member such as a plate, a sheet, or a film refers to a principal surface having a large area unless otherwise specified.

In the specification of the present application, a compound represented by a formula (x) is also referred to as a compound (x).

In a chemical formula, Me represents a methyl group; Et represents an ethyl group; and nBu represents an n-butyl group.

In a composition containing one or more type(s) of hydrolyzable silicon compounds, the one or more type(s) of hydrolyzable silicon compounds may be partially hydrolyzed and condensed between the same species or between different species.

In the specification of the present application, a hydrolyzable condensate of one or more type(s) of hydrolyzable silicon compounds is an oligomer (multimer) that is formed as at least a part of a hydrolyzable group contained in one or more type(s) of hydrolyzable silicon compounds is hydrolyzed, and then dehydrated and condensed.

In the specification of the present application, a numerical range indicated by a symbol “-” includes the numerical values before and after the symbol “-” as a lower limit and an upper limit, respectively, unless otherwise specified.

Embodiments according to the present invention will be described hereinafter.

### [Water-Repellent Structure]

A water-repellent structure according to the present disclosure includes a substrate and a water-repellent film formed on a surface of the substrate.

The water-repellent film includes a water-repellent layer and may include one or more other layers.

In other words, the water-repellent film may have a single layer structure consisting of a water-repellent layer alone or a laminated structure including a water-repellent layer and one or more other layers.

The water-repellent film may include, for example, an underlayer below the water-repellent layer.

The water-repellent film may include one or more intermediate layers between the water-repellent layer and the underlayer.

The surface of the water-repellent layer is exposed. Further, the surface of the water-repellent layer is the outermost surface of the water-repellent film and is a water-repellent surface.

The water-repellent film is formed in at least a part of the surface of the substrate.

In the water-repellent structure according to the present disclosure, the water-repellent layer is a siloxane-based inorganic layer containing a siloxane bond (Si—O bond) and one or more type(s) of organic groups bonded to a Si atom and not containing any fluorine atom.

The one or more type(s) of organic groups can be, for example, selected from the group consisting of alkyl groups and alkylene groups.

The underlayer, which the water-repellent structure according to the present disclosure can include, can be a siloxane-based inorganic layer containing a siloxane bond (Si—O bond) and not containing any fluorine atom.

The underlayer can contain one or more type(s) of organic groups bonded to a Si atom.

The water-repellent layer and/or the underlayer can contain one or more type(s) of organic materials.

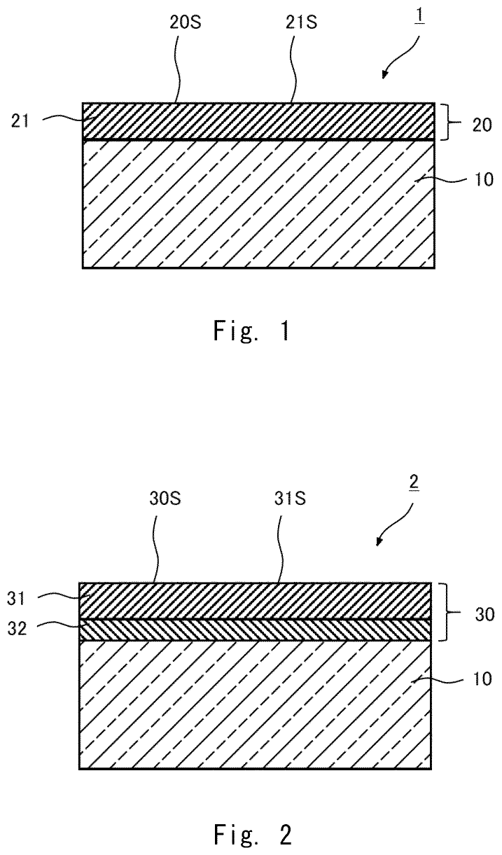

FIG. 1 is a schematic cross-sectional diagram of a water-repellent structure according to a first embodiment of the present invention. The water-repellent structure 1 according to the first embodiment includes a plate-like substrate 10 and a water-repellent film 20 formed on one of the surfaces of the substrate 10. The water-repellent film 20 consists of a water-repellent layer 21 alone, and an exposed surface 21S of the water-repellent layer 21 is the outermost surface 20S of the water-repellent film 20. The water-repellent film 20 may be formed on both surfaces of the substrate 10.

FIG. 2 is a schematic cross-sectional diagram of a water-repellent structure according to a second embodiment of the present invention. The water-repellent structure 2 according to the second embodiment includes a plate-like substrate 10 and a water-repellent film 30 formed on one of the surfaces of the substrate 10. The water-repellent film 30 consists of a water-repellent layer 31 and an underlayer 32 formed below the water-repellent layer 31, and an exposed surface 31S of the water-repellent layer 31 is the outermost surface 30S of the water-repellent film 30. The water-repellent film 30 may be formed on both surfaces of the substrate 10.

In the water-repellent structure according to the present disclosure, the surface of the water-repellent layer has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square.

The root mean square inclination value of the surface elastic modulus in the above-described micron region is 3.5 GPa or higher.

The upper limit value of the root mean square inclination value of the surface elastic modulus in the above-described micron region is not limited to any particular value, and is preferably 35.0 GPa or lower and more preferably 30.0 GPa or lower.

The average elastic modulus in the above-described micron region is not limited to any particular value, and is preferably 2.0 to 14.0 GPa.

In the above-described micron region, the area ratio of the high-elastic modulus region having an elastic modulus of 6.0 GPa or higher is preferably 1 to 50%.

In the above-described micron region, the area ratio of the low-elastic modulus region having an elastic modulus of 4.0 GPa or lower is preferably 10 to 80%.

The elastic modulus distribution (also referred to as elastic modulus mapping) can be measured, for example, by a Bimodal AFM method. For example, the elastic modulus distribution can be measured by using an atomic force microscope (AFM) manufactured by Oxford Instruments and an AM-FM viscoelastic mapping mode which is one of its accessories.

An atomic force microscope (AFM) is a type of scanning probe microscope and detects a force acting between atoms of a sample and atoms of a probe. The probe includes a substrate, a cantilever (cantilever spring) extending from the substrate, and a probe attached to the tip of the cantilever. A force acting on the cantilever (amount of bending) is measured while changing a distance between the sample and the probe, so that a force curve, which is a curve obtained based on plots of a relationship between the distance between the sample and the probe and the force acting on the cantilever (amount of bending), can be obtained. By analyzing this force curve, the elastic modulus distribution on the surface of the sample can be obtained.

Since the measured value may change depending on the used probe, the position of the laser spot, the detector, and the like, the measurement conditions are preferably unchanged for the sake of the data reproducibility.

The atomic force microscope (AFM) is preferably equipped with a photothermal excitation technology in order to vibrate the probe in a stabled manner. The substrate used for calculating an optical lever sensitivity (InvOLS) is preferably a sapphire substrate of which the height of the surface is adjusted so as to be equal to the height of the surface of the sample to be evaluated. In order to keep its tip shape parameter constant, the probe is preferably one made of single-crystal diamond so that the change in the contact state caused by abrasion is small. For the reference elastic modulus used for calculating the tip shape parameter, a polystyrene reference sample (having an elastic modulus of 2.7 GPa) of which the elastic modulus level is close to that of the sample to be evaluated is preferred. In the case of a new probe, it is preferred that the probe be first used to some extent, for example, used to measure a shape of 10 μm square on the surface of a smooth glass about 20 times under the condition of 1 Hz, and then is used for actually measuring the elastic modulus distribution. The height of the surface of the sample to be evaluated is preferably within 1 mm from the surface of the substrate and is preferably set to the height of the surface of the substrate as much as possible.

It is possible to observe the surface of the water-repellent layer by using the AFM and display the elastic modulus distribution on the observation image by using color tones. In the image showing the elastic modulus distribution (also referred to as an elastic modulus image), areas in which the elastic modulus is high are shown in white, and those in which the elastic modulus is low are shown in a deep color. It is possible to measure the area ratio of a high-elastic modulus region having an elastic modulus of 6.0 GPa or higher, the area ratio of a low-elastic modulus region having an elastic modulus of 4.0 GPa or lower, the root mean square inclination value of the surface elastic modulus, and the average elastic modulus of the observation image by using the AFM.

In the specification of the present application, the expression that “an arbitrarily selected micron region of 1 μm square satisfies a specific regulation” means that one or more AFM observation images out of 10 arbitrarily selected AFM observation images of 1 μm square satisfy the above-described regulations. It is preferred that five or more AFM observation images out of 10 arbitrarily selected AFM observation images of 1 μm square satisfy the above-described regulations. It is more preferred that eight or more AFM observation images out of 10 arbitrarily selected AFM observation images of 1 μm square satisfy the above-described regulations. It is particularly preferred that all of 10 arbitrarily selected AFM observation images of 1 μm square satisfy the above-described regulations.

The “water repellency” includes static water repellency, which is such a property that water droplets hardly adhere, and dynamic water repellency (also referred to as a water gliding property), which is such a property that water droplets easily slide down. The water-repellent layer preferably has both excellent static repellency and dynamic water repellency. The static water repellency can be evaluated based on the water contact angle, and the dynamic water repellency (water gliding property) can be evaluated based on the water sliding angle.

The water-repellent layer preferably has satisfactory water repellency in its initial state and has satisfactory durability so that satisfactory water repellency can be maintained even after the water-repellent layer is used for a long time. One of the durability characteristics is abrasion resistance.

For example, in its application as a side glass or the like of a vehicle, a window can be opened and closed by lifting up and down a glass laminate (water-repellent structure) consisting of a glass plate and a water-repellent film. In such application, it is preferred that the water-repellent layer have satisfactory abrasion resistance so that the water repellency does not significantly deteriorate even when the surface of the water-repellent layer is repeatedly rubbed.

In general, in order to reduce the water sliding angle, it is desirable if the elastic modulus of the surface of the water-repellent layer is low. On the other hand, in order to improve the abrasion resistance, it is desirable if the elastic modulus of the surface of the water-repellent layer is high. When the elastic modulus of the surface of the water-repellent layer is lowered, water easily slides down, so that the dynamic water repellency can be improved. However, the abrasion resistance tends to deteriorate. As described above, under the normal circumstances, the dynamic water repellency and the abrasion resistance are characteristics contradictory to each other.

In the water-repellent structure according to the present disclosure, the surface of the water-repellent layer includes a high elastic modulus part having an elastic modulus of 6.0 GPa or higher and a low elastic modulus part having an elastic modulus of 4.0 GPa or lower in an arbitrarily selected micron region of 1 μm square. In the above-described configuration, as a whole, the surface of the water-repellent layer can have both characteristics of a water sliding property and rigidity, so that the abrasion resistance can be improved while maintaining the satisfactory dynamic water repellency.

It is considered that in order to achieve both the dynamic water repellency and the abrasion resistance, it is effective that a high elastic modulus part and a low elastic modulus part exist independently of each other as domains having appropriate sizes. It is considered that the high elastic modulus part existing as a domain having an appropriate size contributes to the improvement of the abrasion resistance, and the low elastic modulus part existing as a domain having an appropriate size lowers the water sliding angle and thereby contributes to the improvement of the dynamic water repellency.

In view of the balance between the improvement of the dynamic water repellency and that of the abrasion resistance, the root mean square inclination value of the surface elastic modulus in the micron region is 3.5 GPa or higher, preferably 4.0 GPa or higher, more preferably 4.5 GPa or higher, and particularly preferably 5.0 GPa or higher.

In view of the balance between the improvement of the dynamic water repellency and that of the abrasion resistance, the root mean square inclination value of the surface elastic modulus in the micron region is preferably 35.0 GPa or lower, more preferably 30.0 GPa or lower, particularly preferably 25.0 GPa or lower, and most preferably 20.0 GPa or lower.

When the root mean square inclination value is within the above-described range, the high elastic modulus part and the low elastic modulus part exist independently of each other as domains having appropriate sizes, and both the dynamic water repellency and the abrasion resistance can be achieved in a well-balanced manner.

It is considered that when the root mean square inclination value is too small, the surface of the water-repellent layer is in a state in which the high elastic modulus part and the low elastic modulus part exist independently of each other as domains, but the sizes of these domains are larger than the suitable sizes, or in a state in which there is no clear boundary between the high elastic modulus part and the low elastic modulus part, and hence the high elastic modulus part and the low elastic modulus part do not exist independently of each other as domains. It is considered that when the root mean square inclination value is too large, the surface of the water-repellent layer is in a state in which the high elastic modulus part and the low elastic modulus part exist independently of each other as domains, but the sizes of these domains are smaller than the suitable sizes. It is considered that in such a state, it is difficult to achieve both the dynamic water repellency and the abrasion resistance in a well-balanced manner.

In view of the balance between the improvements of the dynamic water repellency and the abrasion resistance, the average elastic modulus in the micron region on the surface of the water-repellent layer is preferably 2.0 to 14.0 GPa and more preferably 2.4 to 10.0 GPa.

In view of the balance between the improvements of the water repellency and the abrasion resistance, the area ratio of the high-elastic modulus region having an elastic modulus of 6.0 GPa or higher in the micron region on the surface of the water-repellent layer is preferably 1 to 50%, more preferably 2 to 40%, and particularly preferably 3 to 30%. The area ratio of the low-elastic modulus region having an elastic modulus of 4.0 GPa or lower is preferably 10 to 80%, more preferably 20 to 78%, and particularly preferably 40 to 72%.

The initial water contact angle on the surface of the water-repellent layer is preferably 90° or larger, more preferably 95° or larger, and particularly preferably 100° or larger. The upper limit of the initial water contact angle is not limited to any particular angle, and is, for example, 110°.

The initial water sliding angle of the surface of the water-repellent layer is preferably 30° or smaller, more preferably 26° or smaller, and particularly preferably 25° or smaller. The lower limit value of the initial water sliding angle is not limited to any particular angle, and is, for example, 3°.

Note that in the specification of the present application, the “initial” is defined as a period from the time when the formation of the water-repellent film on the substrate is completed to the time when 150 hours has elapsed in the state where the water-repellent film is left undisturbed at a normal temperature (20 to 25° C.) without being subject to any special process or operation.

“The time when the formation of the water-repellent film is completed” is the time when the curing of the coating film made of the water-repellent layer forming composition is completed.

The initial water contact angle and the initial water sliding angle can be measured by a method described in [Example] section described later.

The abrasion resistance of the surface of the water-repellent layer can be evaluated based on the water contact angle that is measured after an abrasion test is carried out.

The abrasion test can be performed, for example, as follows.

A reciprocation-type traverse tester manufactured by K-N-T corporation is prepared as a tester.

As dust solutions, eight solutions in each of which a respective one of eight types of test powders 1 specified in JIS Z8901 is dispersed in pure water at a concentration of 2.5 mass % are prepared.

An automotive door molding “MOULDING 75720-47010” manufactured by Toyota Motor Corporation, which is cut into a rectangle having an area of 4.0 cm², is prepared as an abrasion member.

A part of the above-described abrasion member, which comes into contact with a glass of an actual vehicle, is impregnated with 20 μL of the aforementioned dust solution, and then attached to the tester. Then, the surface of the water-repellent layer of the water-repellent structure is subjected to an abrasion process by reciprocating the abrasion member on the surface of the water-repellent layer 5,000 times under the conditions of a load of 350 g, a speed of 50 reciprocations per minute, and a frictional distance of 10 cm.

In the water-repellent layer of the water-repellent structure according to the present disclosure, the water contact angle on the surface can be maintained at 80° or larger after the above-described abrasion test.

### (Substrate)

The substrate is not limited to any particular substrate as long as it is one that needs to be water-repellent.

Examples of materials of which such substrates are made include glasses, metals, resins, ceramics, and combinations thereof. The water-repellent film included in the water-repellent structure according to the present disclosure can be transparent. According to the technology in accordance with the present disclosure, a transparent substrate made of a material such as a glass and a transparent resin can be made water-repellent while maintaining its transparency.

Examples of forms of substrates include a planar member such as a plate, a sheet, and a film. The planar member may be entirely flat or at least partially curved.

In the application for a window glass or the like of a transportation apparatus, the substrate may include a glass plate. Examples of glass plates include a tempered glass, a laminated glass obtained by laminating a plurality of glass plates with an intermediate film(s) interposed therebetween, and an organic glass. In the application for a window glass or the like of a transportation apparatus, a tempered glass or a laminated glass is preferred.

The type of glass plate of which a tempered glass or a laminated glass is formed is not limited to any particular type, and examples thereof include soda lime glass, borosilicate glass, aluminosilicate glass, lithium silicate glass, quartz glass, sapphire glass, and non-alkali glass.

A tempered glass is obtained by performing a strengthening process on the above-described glass plate or the like by using a known method such as an ion exchange method and an air-cooled tempering method. The tempered glass is preferably an air-cooled tempered glass.

The thickness of the tempered glass is not limited to any particular thickness and is designed according to the application. In the application for a window glass for vehicle (a windshield, a side glass, a rear glass, or the like), the thickness is preferably 2 to 6 mm.

The thickness of the laminated glass is not limited to any particular thickness and is designed according to the application. In the application for a window glass for vehicle (a windshield, a side glass, a rear glass, or the like), the thickness is preferably 2 to 6 mm.

In the application for a window glass for vehicle or the like, the glass plate is processed into a shape having a curved surface.

Examples of resins include acrylic resins such as polymethylmethacrylate; aromatic polycarbonate resins such as polyphenylene carbonate; aromatic polyester resins such as polyethylene terephthalate (PET).

The water-repellent film is formed at least in a region on the surface of the substrate which needs to be water-repellent. When the substrate is a planar member such as a plate, a sheet, and a film, the water-repellent film can be formed on at least one of the surfaces of the planar member.

### (Water-Repellent Layer)

The water-repellent film includes a water-repellent layer containing a siloxane bond (Si—O bond) and one or more type(s) of organic groups bonded to a Si atom and not containing any fluorine atom.

The one or more type(s) of organic groups can be selected from the group consisting of alkyl groups and alkylene groups.

The surface of the water-repellent layer has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square. The root mean square inclination value of the surface elastic modulus in the above-described micron region is 3.5 GPa or higher. The root mean square inclination value of the surface elastic modulus in the micron region is preferably 35.0 GPa or lower, and more preferably 30.0 GPa or lower.

The water-repellent layer can be formed, for example, by using a water-repellent layer forming composition containing one or more type(s) of hydrolyzable silicon compounds (ST) which may be partially hydrolyzed and condensed between the same species or between different species.

The water-repellent layer is preferably formed by using a water-repellent layer forming composition containing one or more type(s) of hydrolyzable silicon compounds (ST) which may be partially hydrolyzed and condensed between the same species or between different species, and one or more type(s) of organic solvents (VT).

The water-repellent layer can be a dry-cured substance of the above-described water-repellent layer forming composition.

The one or more type(s) of hydrolyzable silicon compounds (ST) is preferably a plurality of types of hydrolyzable silicon compounds which contain one or more type(s) of hydrolyzable silicones (SC) and one or more type(s) of hydrolyzable alkylsilanes (SR), and may be partially hydrolyzed and condensed between the same species or between different species.

An HSP value, which is a solubility parameter according to Hansen's definition, (hereinafter, it is also referred to simply as an “HSP value”) of the one or more type(s) of organic solvents (VT) is preferably 10.8 to 12.1. When the organic solvent (VT) is a mixed solvent, the HSP value is the HSP value of the mixed solvent.

The water-repellent layer can be a dry-cured substance of a composition containing:
a plurality of types of hydrolyzable silicon compounds (ST) which may be partially hydrolyzed and condensed between the same species or between different species and which include one or more type(s) of hydrolyzable silicones (SC) containing a hydrolyzable group and one or more type(s) of hydrolyzable alkylsilanes (SR) containing a hydrolyzable group and an alkyl group; and
one or more type(s) of organic solvents (VT);
in which an amount of the one or more type(s) of hydrolyzable alkylsilanes (SR) is 1 to 50 pts·mass based on 100 pts·mass of a total amount of the one or more type(s) of hydrolyzable silicones (SC) and the one or more type(s) of hydrolyzable alkylsilanes (SR),
and in which an HSP value of the one or more type(s) of organic solvents is 10.8 to 12.1.

By using the above-described composition, the above-described water-repellent layer having a specific elastic modulus distribution can be easily formed.

### <Hydrolyzable Silicone (SC)>

The hydrolyzable silicone (SC) is preferably a compound represented by the below-shown Formula (1) (also referred to as Compound (1)). One or more type(s) of Compounds 1 can be used.

R¹³—(SiR¹²₂O)ₖ₁—SiR¹²₂—Y¹—Si(R¹¹)₃₋ₙ₁(X¹)ₙ₁ (1)

(in the above-shown formula: R¹³ represents an alkyl group having a carbon atom number of 1 to 30; R¹² each independently represents an alkyl group having a carbon atom number of 3 or smaller; Y¹ represents an alkylene group having a carbon atom number of 2 to 4 or an oxygen atom; R¹¹ each independently represents a monovalent hydrocarbon group; X¹ each independently represents a hydrolyzable group; X¹ may be hydrolyzed into a hydroxyl group; k1 is an integer of 10 to 300; and n1 is an integer of 1 to 3).

Compound (1) is a linear polyorganosiloxane having an alkyl group (R¹³) at one end and a hydrolyzable group (X¹) at the other end.

The water-repellent layer obtained by using Compound (1) is considered to be a layer in which X¹ or a group derived from X¹ of Compound (1) is bonded to the base. The water-repellent layer obtained by using Compound (1) has both excellent static water repellency and excellent dynamic water repellency. The water-repellent layer also has an excellent abrasion resistance.

Note that in the specification of the present application, the “base of the water-repellent layer” is the substrate or the underlayer immediately below the water-repellent layer.

It is considered that on the surface of the water-repellent layer obtained by using one or more type(s) of Compounds 1 and one or more type(s) of hydrolyzable alkylsilanes (SR), a high elastic modulus part of 6.0 GPa or higher is easily formed by an alkyl group and/or an alkylene group derived from Compound (1) and the hydrolyzable alkylsilane (SR), so that durability such as abrasion resistance can be effectively improved.

In order to improve the solubility of Compound (1) in the water-repellent layer forming composition, the coating property of the water-repellent layer forming composition, and the abrasion resistance of the water-repellent layer, R¹³ is an alkyl group having a carbon atom number of 1 to 30.

Examples of the alkyl group include a linear alkyl group, a branched alkyl group, and an alkyl group having a cyclic structure. Further, the linear alkyl group is preferred.

As the carbon atom number of the alkyl group in Compound (1) increases, the maximum elastic modulus of the surface of the water-repellent layer increases, so that the abrasion resistance of the water-repellent layer tends to improve, but the dynamic water repellency tends to decrease.

The lower limit of the carbon atom number of the alkyl group is preferably 2, more preferably 3, and particularly preferably 4.

The upper limit of the carbon atom number of the alkyl group is preferably 20 and more preferably 10.

A plurality of types of Compounds (1) of which the carbon atom numbers of R¹³ are different from one another may be used in combination. For example, Compound (1) of which the carbon atom number of R¹³ is 4 or larger and Compound (1) of which the carbon atom number of R¹³ is 3 or smaller may be used in combination.

R¹² each independently represents an alkyl group having a carbon atom number of 3 or smaller, and preferably represents a linear alkyl group of which the carbon atom number is 3 or smaller, and more preferably represents a methyl group. A plurality of R¹² may be the same as each other or not the same as each other, and preferably the same as each other.

Y¹ represents an alkylene group having a carbon atom number of 2 to 4 or an oxygen atom. When Y¹ is an alkylene group, its carbon atom number is preferably 2 or 3.

When Y¹ is an alkylene group, Compound (1) may be a mixture of Compound (1) in which Y¹ is a linear alkylene group and Compound (1) in which Y¹ is a branched chain alkylene group. For example, when Y¹ is an alkylene group having a carbon atom number of 2, this group is expressed as —C₂H₄—. However, Compound (1) may be a mixture of Compound (1) in which Y¹ is —CH₂CH₂— and Compound (1) in which Y¹ is —CH(CH₃)—. However, it is preferred that the ratio of Compound (1) in which Y¹ is a linear alkylene group is high in Compound (1) in which Y¹ is an alkylene group.

R¹¹ each independently represents a monovalent hydrocarbon group. Examples of monovalent hydrocarbon groups include an alkyl group, a cycloalkyl group, an alkenyl group, and an aryl group. R¹¹ is preferably a monovalent saturated hydrocarbon group. The carbon atom number of R¹¹ is preferably 1 to 6, more preferably 1 to 3, and particularly preferably 1 or 2. In view of the availability of raw materials and the ease of the synthesis of Compound (1), R¹¹ is preferably an alkyl group having a carbon atom number of 1 to 6, more preferably an alkyl group having a carbon atom number of 1 to 3, and particularly preferably an alkyl group having a carbon atom number of 1 or 2. When there are a plurality of R¹¹ in Formula (1), the plurality of R¹¹ may be the same as each other or not the same as each other. However, the plurality of R¹¹ are preferably the same as each other in view of the availability of raw materials.

X¹ represents a hydrolyzable group, and Si—X¹ is hydrolyzed and Si—OH is thereby generated. Therefore, X¹ may be hydrolyzed into a hydroxyl group in the composition. Examples of hydrolyzable groups include an alkoxy group, an acyloxy group, a ketoxime group, an alkenyloxy group, an aminoxy group, an amide group, an isocyanate group, and a halogen atom. In view of the balance between the chemical stability of Compound (1) and the ease of the hydrolysis, an alkoxy group, an isocyanate group, a halogen atom and the like are preferred. The alkoxy group is preferably an alkoxy group having a carbon atom number of 1 to 4, and more preferably a methoxy group, an ethoxy group, or the like. The halogen atom is preferably a chlorine atom or the like. X¹ is particularly preferably a methoxy group, an ethoxy group, a chlorine atom, or the like. When there are a plurality of X¹ in Formula (1), the plurality of X¹ may be the same as each other or not the same as each other. However, the plurality of X¹ are preferably the same as each other in view of the availability of raw materials.

k1 is 10 to 300, preferably 20 to 240, and more preferably 30 to 120. When k1 is within the above-described range, both static water repellency and dynamic water repellency can be achieved in the water-repellent layer. Note that Compound (1) may be a mixture of a plurality of types of Compounds (1) of which k1 are different from one another. In this case, k1 represents an average value.

n1 is an integer of 1 to 3, and is preferably 2 or 3, and particularly preferably 3 in order to improve the adhesion between the water-repellent layer and the base.

Compound (1) can be manufactured by a known method, for example, by a method disclosed in Patent Literature 1. A commercial product may be used as Compound (1).

### <Hydrolyzable Alkylsilane (SR)>

The hydrolyzable alkylsilane (SR) is preferably a compound represented by a below-shown Formula (2) (also referred to as Compound (2)). One or more type(s) of Compounds (2) can be used.

R²²—Si(R²¹)₃₋ₙ₂(X²)ₙ₂ (2)

(in the above-shown formula: R²² represents an alkyl group having a carbon atom number of 1 to 30; R²¹ each independently represents a monovalent hydrocarbon group; X² each independently represents a hydrolyzable group; X² may be hydrolyzed into a hydroxyl group; and n2 is an integer of 1 to 3).

Compound (2) is alkylsilane having an alkyl group (R²²) at one end and a hydrolyzable group (X²) at the other end.

The water-repellent layer obtained by using Compound (2) is considered to be a layer in which X² or a group derived from X² of Compound (2) is bonded to the base.

A water-repellent layer obtained by using one or more type(s) of hydrolyzable silicones (SC) (preferably one or more type(s) of Compounds (1)) and one or more type(s) of hydrolyzable alkylsilanes (SR) (preferably one or more type(s) of Compounds (2)) has both excellent static water repellency and excellent dynamic water repellency and also has an excellent abrasion resistance.

It is considered that when a hydrolyzable silicone (SC) having a relatively large molecular weight and a hydrolyzable alkylsilane (SR) having a relatively small molecular weight are used in combination, the gap between layers is filled with the hydrolyzable alkylsilane (SR) having a relatively small molecular weight or a reaction product thereof, so that a dense water-repellent layer having excellent abrasion resistance can be obtained.

Further, it is considered that on the surface of the water-repellent layer obtained by using one or more type(s) of hydrolyzable alkylsilanes (SR), a high elastic modulus part of 6.0 GPa or higher is easily formed by an alkyl group and/or an alkylene group derived from one or more type(s) of hydrolyzable alkylsilanes (SR), so that durability such as abrasion resistance can be effectively improved.

In order to improve the solubility of Compound (2) in the water-repellent layer forming composition, the coating property of the water-repellent layer forming composition, and the abrasion resistance of the water-repellent layer, R²² is an alkyl group having a carbon atom number of 1 to 30.

Examples of the alkyl group include a linear alkyl group, a branched alkyl group, and an alkyl group having a cyclic structure. Further, the linear alkyl group is preferred.

It is considered that since the one or more type(s) of hydrolyzable alkylsilanes (SR) forms a domain having an appropriate size and having a high elastic modulus, the root mean square inclination value can be adjusted into a suitable range.

When the carbon chain length of the alkyl group of the hydrolyzable alkylsilane (SR) is too short, there is a possibility that a domain having a high elastic modulus is hardly formed, whereas when the carbon chain length is too long, there is a possibility that the size of the domain having a high elastic modulus become too large. When the carbon chain length of the alkyl group of the hydrolyzable alkylsilane (SR) is within the appropriate range, it is easy to form a domain having an appropriate size and having a high elastic modulus, and to adjust the root mean square inclination value into the appropriate range.

The lower limit of the carbon atom number of the alkyl group is preferably 2, more preferably 5, and particularly preferably 8. The upper limit of the carbon atom number of the alkyl group is preferably 25 and more preferably 20.

A plurality of types of Compounds (2) of which the carbon atom numbers of R²² are different from one another may be used in combination. For example, Compound (2) of which the carbon atom number of R²² is 8 or larger and Compound (2) of which the carbon atom number of R²² is 7 or smaller may be used in combination.

R²¹ each independently represents a monovalent hydrocarbon group; Examples of monovalent hydrocarbon groups include an alkyl group, a cycloalkyl group, an alkenyl group, and an aryl group. R²¹ is preferably a monovalent saturated hydrocarbon group. The carbon atom number of R²¹ is preferably 1 to 6, more preferably 1 to 3, and particularly preferably 1 or 2. In view of the availability of raw materials and the ease of the synthesis of Compound (2), R²¹ is preferably an alkyl group having a carbon atom number of 1 to 6, more preferably an alkyl group having a carbon atom number of 1 to 3, and particularly preferably an alkyl group having a carbon atom number of 1 or 2. When there are a plurality of R²¹ in Formula (2), the plurality of R²¹ may be the same as each other or not the same as each other. However, the plurality of R²¹ are preferably the same as each other in view of the availability of raw materials.

X² represents a hydrolyzable group, and Si—X² is hydrolyzed and Si—OH is thereby generated. Therefore, X² may be hydrolyzed into a hydroxyl group in the composition. Examples of hydrolyzable groups include an alkoxy group, an acyloxy group, a ketoxime group, an alkenyloxy group, an amino group, an aminoxy group, an amide group, an isocyanate group, and a halogen atom. In view of the balance between the chemical stability of Compound (2) and the ease of the hydrolysis, an alkoxy group, an isocyanate group, a halogen atom and the like are preferred. The alkoxy group is preferably an alkoxy group having a carbon atom number of 1 to 4, and more preferably a methoxy group, an ethoxy group, or the like. The halogen atom is preferably a chlorine atom or the like. X² is particularly preferably a methoxy group, an ethoxy group, a chlorine atom, or the like. When there are a plurality of X² in Formula (2), the plurality of X² may be the same as each other or not the same as each other. However, the plurality of X² are preferably the same as each other in view of the availability of raw materials.

n2 is an integer of 1 to 3, and is preferably 2 or 3, and particularly preferably 3 in order to improve the adhesion between the water-repellent layer and the base.

Examples of preferred Compounds (2) include a compound in which: R²² is a linear alkyl group having a carbon atom number of 8 to 20; X² is a methoxy group, an ethoxy group, or a chlorine atom; and n2 is 3. Specific examples include octyltrimethoxysilane, octyltrichlorosilane, octadecyltrimethoxysilane, and octadecyltrichlorosilane.

Compound (2) can be manufactured by a known method, or a commercial product may be used as Compound (2).

### <Other Hydrolyzable Silicon Compound>

The one or more type(s) of hydrolyzable silicon compounds (ST) can include one or more type(s) of other hydrolyzable silicon compounds other than the hydrolyzable silicone (SC) and the hydrolyzable alkylsilane (SR).

### <Mixing Ratio>

In the water-repellent layer forming composition, the amount of one or more type(s) of hydrolyzable silicones (SC) is preferably 99 to 50 pts·mass and the amount of one or more type(s) of hydrolyzable alkylsilanes (SR) is preferably 1 to 50 pts·mass when the total amount of the one or more type(s) of hydrolyzable silicones (SC) and one or more type(s) of hydrolyzable alkylsilanes (SR) is 100 pts·mass.

By adjusting the mixing ratio as described above, it becomes easy to form a water-repellent layer having the above-described specific elastic modulus distribution, satisfactory water repellency in the initial state and having satisfactory abrasion resistance so that the water repellency does not significantly deteriorate even when the surface of the water-repellent layer is repeatedly rubbed.

The amount of one or more type(s) of hydrolyzable silicones (SC) is more preferably 97 to 75 pts·mass and the amount of one or more type(s) of hydrolyzable alkylsilanes (SR) is more preferably 3 to 25 pts·mass when the total amount of the one or more type(s) of hydrolyzable silicones (SC) and one or more type(s) of hydrolyzable alkylsilanes (SR) is 100 pts·mass.

### <Organic Solvent (VT)>

As the organic solvent (VT), one capable of dissolving the solid content contained in the water-repellent layer forming composition is used. Examples of the organic solvent (VT) include alcohols, ethers, ketones, aromatic hydrocarbons, paraffinic hydrocarbons, and acetic esters. One or more type(s) of an organic solvents (VT) can be used.

When the organic solvent is included in the raw material of which the water-repellent layer forming composition is made, the one or more type(s) of organic solvents (VT) includes the organic solvent contained in the raw material.

An HSP value, which is a solubility parameter according to Hansen's definition, of the one or more type(s) of organic solvents (VT) contained in the water-repellent layer forming composition is preferably 10.8 to 12.1. When the organic solvent (VT) is a mixed solvent, the HSP value is the HSP value of the mixed solvent. By using the one or more type(s) of organic solvents (VT) having the HSP value of 10.8 to 12.1, it becomes easy to form a water-repellent layer having the above-described specific elastic modulus distribution, satisfactory water repellency in the initial state and having satisfactory abrasion resistance so that the water repellency does not significantly deteriorate even when the surface of the water-repellent layer is repeatedly rubbed.

The content (in the case of a plurality of species, the total amount) of the organic solvent (VT) contained in the water-repellent layer forming composition is not limited to any particular value. In view of the control of thickness of the water-repellent layer, the uniformity of the water-repellent layer, economy, and workability, the content of the organic solvent (VT) is preferably 80 to 98 mass %, and more preferably 85 to 95 mass %.

### <Water>

The water-repellent layer forming composition may contain water as required.

When water is included in the raw material of which the water-repellent layer forming composition is made, the aforementioned water includes the water contained in the raw material.

In a step of forming a water-repellent layer, since the hydrolyzation condensation reaction of the one or more type(s) of hydrolyzable silicon compounds (ST) can be carried out by using moisture contained in the atmosphere, the water-repellent layer forming composition does not necessarily have to contain water.

The content of water in the water-repellent layer forming composition is not limited to any particular value, and is, for example, 0 to 2 mass %.

### <Catalyst>

The water-repellent layer forming composition may contain one or more type(s) of catalysts as required.

When a catalyst is included in the raw material of which the water-repellent layer forming composition is made, the one or more type(s) of catalysts includes the catalyst contained in the raw material.

Examples of catalysts include an acid catalyst and an alkaline catalyst. Examples of acid catalysts include hydrochloric acid, nitric acid, acetic acid, sulfuric acid, phosphoric acid, sulfonic acid, methanesulfonic acid, and p-toluenesulfonic acid. Examples of alkaline catalysts include sodium hydroxide, potassium hydroxide, and ammonia. The catalyst is preferably an acid catalyst. The catalyst may be used in the form of an aqueous solution.

The content of the catalyst in the water-repellent layer forming composition is not limited to any particular value. The content (in the case of a plurality of species, the total amount) of the one or more type(s) of catalysts is preferably 0.01 to 10 mass % based on 100 mass % of the content (in the case of a plurality of species, the total amount) of the one or more type(s) of hydrolyzable silicon compounds (ST).

When the one or more type(s) of hydrolyzable silicon compounds (ST) contains a chlorine atom as a hydrolyzable group, the compound is highly reactive. Therefore, in view of the stability of the storage of the water-repellent layer forming composition, the water-repellent layer forming composition preferably contains substantially no water and no catalyst. Containing substantially no component or the like means that the content of the component or the like in the water-repellent layer forming composition is 0.3 mass % or smaller.

### <Other Optional Component>

The water-repellent layer forming composition may contain one or more type(s) of other optional components other than the components described above as required. Examples of other optional components include additives such as metal oxide particles; coloring materials such as dyes and pigments; antifouling materials; and various resins.

### <Method for Forming Water-Repellent Layer>

As an example, a method for forming a water-repellent layer includes:

a step of preparing a water-repellent layer forming composition containing one or more type(s) of hydrolyzable silicon compounds (ST) which may be partially hydrolyzed and condensed between the same species or between different species, and one or more type(s) of organic solvents (VT);
a step of applying the above-described water-repellent layer forming composition to at least a part of a surface of a substrate, drying (partially drying or completely drying) the applied water-repellent layer forming composition as required, and thereby forming an uncured water-repellent layer; and
a step of curing the uncured water-repellent layer.

Prior to applying the water-repellent layer forming composition, an underlayer or an uncured underlayer may be formed on the surface of the substrate.

Examples of a method for applying a water-repellent layer forming composition include hand coating, brush coating, flow coating, rotary coating, dip coating, squeegee coating, and spray coating.

Examples of a method for drying a coating layer composed of a water-repellent layer forming composition include, for example, a method in which a substrate on which a coating layer is formed is left undisturbed in an arbitrary atmosphere such as an atmospheric atmosphere and a nitrogen atmosphere at a normal temperature under a normal pressure. The relative humidity of the atmosphere in the drying step is preferably not high, and is preferably lower than 50%, and more preferably 40% or lower.

The curing conditions of the uncured water-repellent layer can be determined as appropriate according to the composition, concentration, and the like of the water-repellent layer forming composition.

The uncured water-repellent layer can be cured in an arbitrary atmosphere such as an atmospheric atmosphere and a nitrogen atmosphere under a normal pressure. The temperature of the atmosphere is not limited to any particular temperature, and is preferably 20 to 80° C. The relative humidity of the atmosphere is not limited to any particular humidity, and is preferably 0 to 90% and more preferably 50 to 90%. When the relative humidity of the atmosphere is 50% or higher, the uncured water-repellent layer can be effectively cured by using moisture contained in the atmosphere.

The time required for the curing depends on the composition, concentration, curing conditions, and the like of the water-repellent layer forming composition. The time required for the curing is preferably 10 minutes to 72 hours.

The thickness of the water-repellent layer is not limited to any particular thickness as long as satisfactory water repellency and satisfactory abrasion resistance can be imparted to the water-repellent film, and is preferably 50 nm or smaller in view of the economy. The lower limit value of the water-repellent layer is a thickness of a monomolecular layer.

### (Underlayer)

The water-repellent film may include an underlayer containing a siloxane bond and not containing any fluorine atom below the water-repellent layer. The underlayer can improve the moisture resistance and adhesion of the water-repellent film. The underlayer can also function as a barrier layer for preventing components such as alkali from being transferred from the substrate to the water-repellent film.

The underlayer can be formed by using, for example, an underlayer forming composition containing one or more type(s) of hydrolyzable silicon compounds (SU) which may be partially hydrolyzed and condensed between the same species or between different species, selected from the group consisting of compounds represented by the below-shown Formula (3) (also referred to as Compound (3)) and compounds represented by the below-shown Formula (4) (also referred to as Compound (4)).

Si(X³)₄ (3)

(In the above-shown formula, X³ each independently represents a hydrolyzable group; and X³ may be hydrolyzed into a hydroxyl group), and

X⁴₃Si—(CH₂)ₘ—SiX⁴₃ (4)

(In the above-shown formula, X⁴ each independently represents a hydrolyzable group; X⁴ may be hydrolyzed into a hydroxyl group; and m is an integer of 1 to 8).

The underlayer can be a dry-cured substance of the above-described underlayer forming composition.

X³ in Formula (3) represents a hydrolyzable group, and Si—X³ is hydrolyzed and Si—OH is thereby generated. Therefore, X³ may be hydrolyzed into a hydroxyl group in the composition. Examples of hydrolyzable groups include an alkoxy group, an acyloxy group, a ketoxime group, an alkenyloxy group, an amino group, an aminoxy group, an amide group, an isocyanate group, and a halogen atom. In view of the balance between the chemical stability of Compound (3) and the case of the hydrolysis, an alkoxy group, an isocyanate group, a halogen atom and the like are preferred. The alkoxy group is preferably an alkoxy group having a carbon atom number of 1 to 4, and more preferably a methoxy group, an ethoxy group, or the like. The halogen atom is preferably a chlorine atom or the like. X³ is particularly preferably a methoxy group, an ethoxy group, a chlorine atom, or the like. A plurality of X³ in Formula (3) may be the same as each other or not the same as each other. However, the plurality of X³ are preferably the same as each other in view of the availability of raw materials. The same applies to X⁴ in Formula (4).

In Formula (4), m is an integer of 1 to 8 and preferably an integer of 1 to 3. When m is within the above-described range, the underlayer has moderate hydrophobicity, so that the moisture resistance of the water-repellent film can be improved, and the obtained water-repellent film has satisfactory dynamic water repellency.

Examples of preferred Compounds (3) include Si(NCO)₄, Si(OCH₃)₄, and Si(OC₂H₅)₄.

Examples of preferred Compounds (4) include (CH₃O)₃SiCH₂CH₂Si(OCH₃)₃, (C₂H₅O)₃SiCH₂CH₂Si(OC₂H₅)₃, (OCN)₃SiCH₂CH₂Si(NCO)₃, Cl₃SiCH₂CH₂SiCl₃, and (CH₃O)₃SiCH₂CH₂CH₂CH₂CH₂CH₂Si(OCH₃)₃.

### <Organic Solvent>

The underlayer forming composition may contain one or more type(s) of organic solvents (VU). Examples of the organic solvent (VU) include those shown as examples of the organic solvent (VU) of the water-repellent layer forming composition. An HSP value of one or more type(s) of organic solvents (VU) contained in the underlayer forming composition is not limited to any particular value.

When an organic solvent is contained in the raw material of which the underlayer forming composition is made, the one or more type(s) of organic solvents (VU) includes the organic solvent contained in the raw material.

The content of the organic solvent (VU) contained in the underlayer forming composition is not limited to any particular value. In view of the control of thickness of the underlayer, the uniformity of the underlayer, economy, and workability, the content of the organic solvent (VU) is preferably 80 to 99 mass %, and more preferably 90 to 98 mass %.

### <Water>

The underlayer forming composition may contain water as required.

When water is included in the raw material of which the underlayer forming composition is made, the aforementioned water includes the water contained in the raw material.

In a step of forming an underlayer, since the hydrolyzation condensation reaction of the one or more type(s) of hydrolyzable silicon compounds (SU) can be carried out by using moisture contained in the atmosphere, the underlayer forming composition does not necessarily have to contain water.

The content of water in the underlayer forming composition is not limited to any particular value, and is, for example, 0 to 10 mass %.

### <Catalyst>

The underlayer forming composition may contain one or more type(s) of catalysts as required. Examples of the catalyst of the underlayer forming composition include those shown as examples of the catalyst of the water-repellent layer forming composition.

When a catalyst is included in the raw material of which the underlayer forming composition is made, the one or more type(s) of catalysts includes the catalyst contained in the raw material.

The content of the catalyst in the underlayer forming composition is not limited to any particular value. The content (in the case of a plurality of species, the total amount) of the one or more type(s) of catalysts is preferably 0.01 to 10 mass % based on 100 mass % of the content (in the case of a plurality of species, the total amount) of the one or more type(s) of hydrolyzable silicon compounds (SU).

When the one or more type(s) of hydrolyzable silicon compounds (SU) contain a chlorine atom as a hydrolyzable group, the compound is highly reactive. Therefore, in view of the stability of the storage of the underlayer forming composition, the underlayer forming composition preferably contains substantially no water and no catalyst. Containing substantially no component or the like means that the content of the component or the like in the underlayer forming composition is 0.3 mass % or smaller.

### <Other Optional Component>

The underlayer forming composition may contain one or more type(s) of other optional components other than the components described above as required. Examples of other optional components include additives such as metal oxide particles; coloring materials such as dyes and pigments; antifouling materials; and various resins.

### <Method for Forming Underlayer>

A method for forming an underlayer includes:
a step of preparing an underlayer forming composition containing one or more type(s) of hydrolyzable silicon compounds (SU) which may be partially hydrolyzed and condensed between the same species or between different species;
a step of applying the above-described underlayer forming composition to at least a part of a surface of a substrate, drying (partially drying or completely drying) the applied underlayer forming composition as required, and thereby forming an uncured underlayer; and
a step of curing the uncured underlayer.

The uncured underlayer may be cured before applying the water-repellent layer forming composition or simultaneously with the curing of the uncured water-repellent layer.

The method for applying the underlayer forming composition and the method for drying the coating layer consisting of the underlayer forming composition are similar to those for the water-repellent layer forming composition.

The curing conditions of the uncured underlayer can be determined as appropriate according to the composition, concentration, and the like of the underlayer forming composition.

The uncured underlayer can be cured in an arbitrary atmosphere such as an atmospheric atmosphere and a nitrogen atmosphere under a normal pressure. The temperature of the atmosphere is not limited to any particular temperature, and is preferably 20 to 50° C. The relative humidity of the atmosphere is not limited to any particular humidity, and is preferably 50 to 90%. When the relative humidity of the atmosphere is 50% or higher, the uncured underlayer can be effectively cured by using moisture contained in the atmosphere.

The time required for the curing depends on the composition, concentration, curing conditions, and the like of the underlayer forming composition. The time required for the curing is preferably about 1 to 72 hours.

The thickness of the underlayer is not limited to any particular thickness as long as the moisture resistance and adhesion of the water-repellent film can be improved and the underlayer can function as a barrier layer, and is preferably 50 nm or smaller in view of the economy. The lower limit value of the underlayer is a thickness of a monomolecular layer.

The surface of the water-repellent layer included in the water-repellent structure according to the present disclosure has satisfactory water repellency and has both excellent static water repellency and excellent dynamic water repellency.

Water droplets are less likely to adhere to the surface of the water-repellent layer included in the water-repellent structure according to the present disclosure, and even if water droplets adhere to the surface, they are likely to fall down naturally. In the case where the water-repellent structure according to the present disclosure is used as an article for a transportation apparatus, even when water droplets adhere to the surface of the water-repellent layer, the water droplets are likely to fall down because they receive a wind force as the transportation apparatus moves.

The water-repellent layer included in the water-repellent structure according to the present disclosure has satisfactory water repellency in the initial state and has satisfactory durability so that satisfactory water repellency can be maintained even after the water-repellent layer is used for a long time. One of the durability characteristics is abrasion resistance.

The water-repellent layer included in the water-repellent structure according to the present disclosure has a specific elastic modulus distribution, so that the water-repellent layer has satisfactory abrasion resistance so that the water repellency does not significantly deteriorate even when the surface of the water-repellent layer is repeatedly rubbed.

Since the water-repellent layer included in the water-repellent structure according to the present disclosure contains no fluorine atom, there is no need to worry about the influence on the environment.

As described above, according to the present disclosure, it is possible to provide a water-repellent structure including a non-fluorine-based water-repellent layer having satisfactory water repellency in the initial state and having satisfactory abrasion resistance so that the water repellency does not significantly deteriorate even when the surface of the water-repellent layer is repeatedly rubbed.

According to the present disclosure, it is possible to provide a water-repellent layer forming composition of which it is possible to form a non-fluorine-based water-repellent layer having satisfactory water repellency in the initial state and having satisfactory abrasion resistance so that the water repellency does not significantly deteriorate even when the surface of the water-repellent layer is repeatedly rubbed.

### Application

A water-repellent structure according to the present disclosure is suitably used for an article for a transportation apparatus or the like. Examples of transportation apparatuses include a train, an automobile, a ship, and an airplane. Examples of articles include a body, a window glass (a windshield, a side glass, a rear glass, or the like), a mirror, and a bumper.

The water-repellent structure according to the present disclosure is suitably used for a window glass for a transportation apparatus or the like. When the water-repellent structure according to the present disclosure is used for a window glass for a transportation apparatus, the adhesion of rain, frost, ice, snow, and the like can be effectively suppressed. Therefore, work for removing them can be reduced, and a satisfactory field of vision can be easily secured.

### EXAMPLES

The present invention will be described hereinafter based on examples, but the present invention is not limited to the examples shown below. Examples 1-6, 11-14, 21-23 and 31 are examples, and Examples 51, 52, 61, 62, 71 and 72 are comparative examples. The normal temperature is 20 to 25° C. unless otherwise specified.

### Material

Materials shown below were prepared.

### [Compound (1)]

### (Hydrolyzable Silicone (1-1))

A compound (1-m) (10.0 g) represented by the below-shown formula, vinyltrimethoxysilane (1.47 g), and a Pt catalyst (2 mass % xylene solution of 1,3-divinyl-1,1,3,3-tetramethyldisiloxane complex of Pt) (0.015 g) were charged into a reactor (internal volume: 50 mL) equipped with a stirrer and a Dimroth condenser, and the charged mixture was stirred at a room temperature for 24 hours.

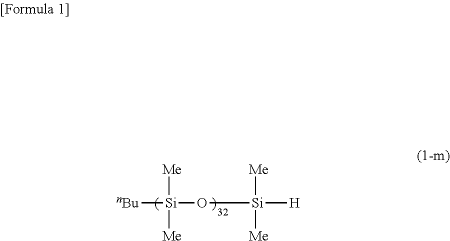

10.4 g of hydrolyzable silicone (1-1) represented by the below-shown formula was obtained by removing volatile components from the obtained reaction crude liquid under conditions of a temperature of 50° C. and a pressure of 1.3 kPa. The yield was 98%.

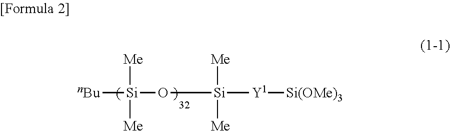

In the above-shown formula, Y¹ represents an ethylene group.

### <Compound (2)>

C18 (OMe): n-octadecyltrimethoxysilane (compound represented by the below-shown formula).

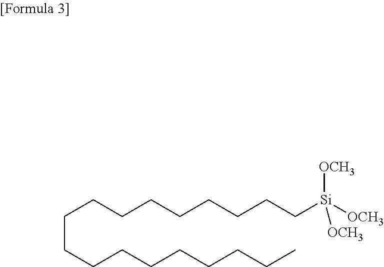 [SMILES: CCCCCCCCCCCCCCCCCC[Si](OC)(OC)OC]

C2 (OMe): ethyltrimethoxysilane,
C6 (OMe): n-hexyltrimethoxysilane,
C8 (OMe): n-octyltrimethoxysilane, and
C12 (OMe): n-dodecyltrimethoxysilane.

### <Compound (3)>

(TEOS) tetraethoxysilane (compound represented by the below-shown formula).

Si(OEt)₄

### <Compound (4)>

(BTE) 1,2-bistrimethoxysilylethane (compound represented by the below-shown formula).

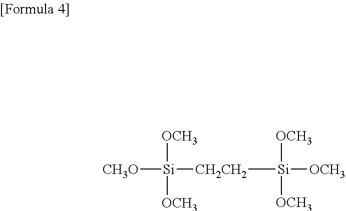

### <Organic Solvent (VT)>

(MeOH) methanol,
(EtOH) ethanol,
(i-PrOH) i-propanol,
(i-BuOH) i-butanol,
(n-PenOH) n-pentanol,
(n-HexOH) n-hexanol,
(n-HepOH) n-heptanol, and
(AcOBu) butyl acetate.

### Evaluation Items and Evaluation Method

A surface of a water-repellent layer of a water-repellent structure obtained in each example was evaluated as follows. Before performing an AFM measurement, the surface of the water-repellent layer was wiped several times with a cotton swab impregnated with i-propanol. Then, the i-propanol was immediately removed by blow removing, so that the surface was cleaned. Before performing other measurements, the surface of the water-repellent layer was cleaned with a paper cloth containing ethanol or butyl acetate.

(Elastic Modulus Distribution, Area Ratio of High-Elastic Modulus Region Having Elastic Modulus of 6.0 Gpa or Higher, Area Ratio of Low Elastic Modulus Region Having Elastic Modulus of 4.0 Gpa or Lower, Root Mean Square Inclination Value of Surface Elastic Modulus, and Average Elastic Modulus)

For the measurement of an elastic modulus distribution (elastic modulus mapping), an atomic force microscope (AFM, “Cypher S” manufactured by Oxford Instruments) equipped with a photothermal excitation technology in order to vibrate the probe in a stabled manner, and an AM-FM viscoelastic mapping mode, which is one of accessories of the atomic force microscope, were used. As the probe, a single-crystal diamond probe (“AD-40” manufactured by Adama Innovation) was used so that the change in the contact state caused by abrasion was small. As the substrate used for calculating an optical lever sensitivity (InvOLS), a sapphire substrate of which the height of the substrate surface was adjusted so as to be equal to the height of the surface of the sample to be evaluated was used. The tip shape parameter was adjusted by using a polystyrene reference sample (elastic modulus of 2.7 GPa) as a reference elastic modulus. In the case of a new probe, it was first used to some extent, for example, used to measure a shape of 10 μm square on the surface of a smooth glass about 20 times under the condition of 1 Hz, and then was used for actually measuring the elastic modulus distribution. The height of the surface of the sample to be evaluated was adjusted within 1 mm from the surface of the substrate and was set to the height of the surface of the substrate as much as possible.

An AFM image of an arbitrarily selected micron region of 1 μm square on the surface of the water-repellent layer of the water-repellent structure was obtained. An elastic modulus distribution was shown on the obtained AFM image by using color tones. Areas in which the elastic modulus was high were shown in white, and those in which the elastic modulus was low were shown in a deep color. The obtained elastic modulus image was analyzed, and the area ratio of a high-elastic modulus region having an elastic modulus of 6.0 GPa or higher, the area ratio of a low-elastic modulus region having an elastic modulus of 4.0 GPa or lower, the root mean square inclination value of the surface elastic modulus, and the average elastic modulus were obtained.

### (Initial Water Contact Angle)

A water droplet having a diameter of 1 mm was placed on the surface of the water-repellent layer of the water-repellent structure, and its water contact angle was measured by using a full-automatic contact angle meter (“DM-701” manufactured by Kyowa Interface Science Co., Ltd). Measurements were made at six different points on the surface of the water-repellent layer, and the average value of them was used as data thereof.

### (Initial Water Sliding Angle)

A water droplet of 50 μL was dropped on the surface of the water-repellent layer of the water-repellent structure horizontally held with respect to the ground surface, and the inclination angle of the water-repellent structure with respect to the horizontal plane was increased by 4° per minute. The inclination angle (sliding angle) of the water-repellent structure with respect to the horizontal plane at the time when the water droplet began to slide down was measured by using a sliding angle measurement system (“SA-11” manufactured by Kyowa Interface Science Co., Ltd). Measurements were made at three different points on the surface of the water-repellent layer, and the average value of them was used as data thereof. The smaller the sliding angle is, the better the dynamic water repellency (water gliding property) is.

(Water Contact Angle after Abrasion Test)

A reciprocation-type traverse tester manufactured by K-N-T corporation was prepared as a tester.

As dust solutions, eight solutions in each of which a respective one of eight types of test powders 1 specified in JIS Z8901 was dispersed in pure water at a concentration of 2.5 mass % were prepared.

An automotive door molding “MOULDING 75720-47010” manufactured by Toyota Motor Corporation, which was cut into a rectangle having an area of 4.8 cm², was prepared as an abrasion member.

A part of the abrasion member which came into contact with a glass of an actual vehicle was impregnated with 20 μL of the aforementioned dust solution. This abrasion member was attached to the tester. The surface of the water-repellent layer of the water-repellent structure was subjected to an abrasion process by reciprocating the abrasion member on the surface of the water-repellent layer 5,000 times under the conditions of a load of 3N, a speed of 50 reciprocations per minute, and a frictional distance of 10 cm. The water contact angle on the surface of the water-repellent layer after the above-described abrasion test was obtained by a method similar to the method described in the (Initial Water Contact Angle) section.

### Example 1

### (Preparation of Underlayer Forming Composition (U1))

An underlayer forming composition (U1) was prepared by putting 8.7 g of i-propanol (i-PrOH) into a glass vessel, adding 0.23 g of tetraethoxysilane (TEOS) and 0.22 g of 1,2-bis(triethoxysilyl) ethane (BTE) thereto, dropping 0.84 g of a 0.463 mass % aqueous solution of nitric acid thereon, and stirring the mixture at a normal temperature for about three hours.

### (Preparation of Water-Repellent Layer Forming Composition (T1))

7.2 g of i-butanol (i-BuOH) was put into a glass vessel; 1.7 g of i-propanol (i-PrOH) and 0.99 g of hydrolyzable silicone (1-1) were added thereto; and the mixture was stirred at a normal temperature for about one minute. Next, 0.17 g of a 10 mass % aqueous solution of nitric acid was dropped, and the mixture was stirred at 60° C. for two hours by using a water bath. Then, a water-repellent layer forming composition (T1) was prepared by adding 0.010 g of octadecyltrimethoxysilane (C18OMe) as alkylsilane, and stirring the mixture at 60° C. for one hour.

In the water-repellent layer forming composition (T1), the amount of hydrolyzable silicone was 99.0 mass % and the amount of alkylsilane was 1.0 mass % based on 100 pts·mass of the total amount of the hydrolyzable silicone and the alkylsilane. The used solvent was a mixed solvent of i-BuOH/i-PrOH (mass ratio: 8/2), and the HSP value of this mixed solvent was 11.6. The concentration of the solid content of the water-repellent layer forming composition (T1) was 10 mass %.

### (Manufacturing of Water-Repellent Structure)

A high heat ray absorbing glass (“UVFL” manufactured by AGC Inc., 300 mm×300 mm, thickness of 3.5 mm) was prepared as a substrate.

An uncured underlayer was prepared by applying 0.50 g of an underlayer forming composition (U1) to one of the surfaces of the aforementioned substrate by a squeegee coating method, and drying the applied underlayer forming composition at a normal temperature for about one minute.

Next, 0.50 g of a water-repellent layer forming composition (T1) was applied to the surface of the uncured underlayer by the squeegee coating method. Next, the obtained laminate was left undisturbed for about 15 minutes in a constant temperature and humidity bath in which the temperature was set to 50° C. and the relative humidity was set to 60%. The laminate was taken out of the constant temperature and humidity bath, and the surface of the laminate was wiped with a paper cloth (“KimWipe” manufactured by Kimberly-Clark Corporation) impregnated with 1.0 mL of butyl acetate, so that excess water-repellent layer forming composition was removed. This laminate was left undisturbed for 47 hours in a constant temperature and humidity bath in which the temperature was set to 50° C. and the relative humidity was set to 60%.

Through the above-described processes, a water-repellent structure in which a water-repellent film consisting of an underlayer and a water-repellent layer was formed was obtained on one of the surfaces of the glass plate.

Table 1 shows major manufacturing conditions and evaluation results. In the examples shown in Table 1, conditions that are not shown in the table were common to all the examples.

### Examples 2-6, 11-14, 21-23, 51, 52, 61, 62, 71, 72

In Examples 2-6, 11-14, 21-23, 51, 52, 61, 62, 71 and 72, water-repellent layer forming compositions (T2)-(T6), (T11)-(T14), (T21)-(T23), (T51), (T52), (T61), (T62), (T71) and (T72) were respectively obtained in the same manner as in the preparation of the water-repellent layer forming composition of Example 1, except that at least one of the conditions in regard to the type of hydrolyzable silicone, the type of alkylsilane, the mass ratios of the hydrolyzable silicone and the alkylsilane, and the type of the used solvent was changed in each of these examples.

In each of Examples 2-6, 11-14, 21-23, 51, 52, 61, 71 and 72, a water-repellent structure was obtained in the same manner as in Example 1, except that the water-repellent layer forming composition obtained in the example was used instead of the water-repellent layer forming composition (T1).

In the water-repellent layer forming composition (T62) obtained in Example 62, the compatibility of the materials was poor, so that phase separation occurred and hence no film was formed.

Tables 1 to 6 show major manufacturing conditions and evaluation results.

### Example 31

A water-repellent structure was obtained in the same manner as in Example 3, except that the underlayer forming composition (U1) was not applied and dried.

Table 3 shows major manufacturing conditions and evaluation results.

TABLE 1

| | Example 1 | Example 2 | Example 3 |
|---|---|---|---|
| Presence/absence of underlayer | Provided | Provided | Provided |
| Underlayer forming composition | U1 | U1 | U1 |
| Type of tetrafunctional silane | TEOS | TEOS | TEOS |
| Water-repellent layer forming composition | T1 | T2 | T3 |
| Type of silicone | 1-1 | 1-1 | 1-1 |
| Ratio of silicone [mass %] | 99.0 | 96.1 | 92.6 |
| Type of alkylsilane | Cl8SiOMe | Cl8SiOMe | Cl8SiOMe |
| Ratio of alkylsilane [mass %] | 1.0 | 3.9 | 7.4 |
| Type of mixed solvent | i-BuOH/i-PrOH | i-BuOH/i-PrOH | i-BuOH/i-PrOH |
| (mass ratio) | (80/20) | (80/20) | (80/20) |
| HSP value of mixed solvent | 11.6 | 11.6 | 11.6 |
| Solid content concentration [mass %] | 10 | 10 | 10 |
| Curing condition | 50° C./60% RH | 50° C./60% RH | 50° C. 60% RH |
| Evaluation result | | | |
| Area ratio of region having elastic | 1 | 2 | 6 |
| modulus of 6 GPa or higher [%] | | | |
| Area ratio of region having elastic | 78 | 72 | 41 |
| modulus of 4 Gpa or lower [%] | | | |
| Root mean square inclination value | 3.6 | 4.0 | 8.3 |
| of surface elastic modulus [Sdq] | | | |
| Average elastic modulus [GPa] | 2.0 | 2.4 | 4.3 |
| Initial water contact angle [°] | 103 | 103 | 103 |
| Initial water sliding angle [°] | 5 | 7 | 8 |
| Water contact angle after abrasion test [°] | 81 | 81 | 90 |
| | Example 4 | Example 5 | Example 6 |
| Presence/absence of underlayer | Provided | Provided | Provided |
| Underlayer forming composition | U1 | U1 | U1 |
| Type of tetrafunctional silane | TEOS | TEOS | TEOS |
| Water-repellent layer forming composition | T4 | T5 | T6 |
| Type of silicone | 1-1 | 1-1 | 1-1 |
| Ratio of silicone [mass %] | 75.0 | 67.0 | 50.0 |
| Type of alkylsilane | Cl8SiOMe | Cl8SiOMe | Cl8SiOMe |
| Ratio of alkylsilane [mass %] | 25.0 | 33.0 | 50.0 |
| Type of mixed solvent | i-BuOH/i-PrOH | i-BuOH/i-PrOH | i-BuOH/i-PrOH |
| (mass ratio) | (80/20) | (80/20) | (80/20) |
| HSP value of mixed solvent | 11.6 | 11.6 | 11.6 |
| Solid content concentration [mass %] | 10 | 10 | 10 |
| Curing condition | 50° C. 60% RH | 50° C./60% RH | 50° C. 60% RH |
| Evaluation result | | | |
| Area ratio of region having elastic | 29 | 39 | 43 |
| modulus of 6 GPa or higher [%] | | | |
| Area ratio of region having elastic | 16 | 14 | 10 |
| modulus of 4 Gpa or lower [%] | | | |
| Root mean square inclination value | 17.3 | 30.0 | 8.9 |
| of surface elastic modulus [Sdq] | | | |
| Average elastic modulus [GPa] | 7.8 | 8.6 | 8.9 |
| Initial water contact angle [°] | 103 | 103 | 102 |
| Initial water sliding angle [°] | 15 | 20 | 20 |
| Water contact angle after abrasion test [°] | 96 | 97 | 97 |

TABLE 2

| | Example 11 | Example 12 | Example 13 | Example 14 |
|---|---|---|---|---|
| Presence/absence of underlayer | Provided | Provided | Provided | Provided |
| Underlayer forming composition | U1 | U1 | U1 | U1 |
| Type of tetrafunctional silane | TEOS | TEOS | TEOS | TEOS |
| Water-repellent layer forming composition | T11 | T12 | T13 | T14 |
| Type of silicone | 1-1 | 1-1 | 1-1 | 1-1 |
| Ratio of silicone [mass %] | 92.6 | 92.6 | 92.6 | 92.6 |
| Type of alkylsilane | C18SiOMe | C18SiOMe | C18SiOMe | C18SiOMe |
| Ratio of alkylsilane [mass %] | 7.4 | 7.4 | 7.4 | 7.4 |
| Type of mixed solvent | i-BuOH/EtOH | i-BuOH/MeOH | n-HepOH/i-PrOH | n-HexOH/i-PrOH |
| (mass ratio) | (80/20) | (80/20) | (80/20) | (80/20) |
| HSP value of mixed solvent | 11.8 | 12.0 | 11.0 | 11.1 |
| Solid content concentration [mass %] | 10 | 10 | 10 | 10 |
| Curing condition | 50° C. 60% RH | 50° C. 60% RH | 50° C. 60% RH | 50° C. 60% RH |
| Evaluation result | | | | |
| Area ratio of region having elastic modulus | 6 | 6 | 6 | 6 |
| of 6 GPa or higher [%] | | | | |
| Area ratio of region having elastic modulus | 40 | 39 | 46 | 46 |
| of 4 Gpa or lower [%] | | | | |
| Root mean square inclination value | 8.4 | 8.4 | 7.9 | 7.9 |
| of surface elastic modulus [Sdq] | | | | |
| Average elastic modulus [GPa] | 4.4 | 4.2 | 4.3 | 4.2 |
| Initial water contact angle [°] | 103 | 103 | 103 | 103 |
| Initial water sliding angle [°] | 8 | 8 | 8 | 8 |
| Water contact angle after abrasion test [°] | 90 | 90 | 84 | 83 |

TABLE 3

| | Example 21 | Example 22 | Example 23 | Example 31 |
|---|---|---|---|---|
| Presence/absence of underlayer | Provided | Provided | Provided | Not provided |
| Underlayer forming composition | U1 | U1 | U1 | — |
| Type of tetrafunctional silane | TEOS | TEOS | TEOS | — |
| Water-repellent layer forming composition | T21 | T22 | T23 | T31 |
| Type of silicone | 1-1 | 1-1 | 1-1 | 1-1 |
| Ratio of silicone [mass %] | 92.6 | 92.6 | 67.0 | 92.6 |
| Type of alkylsilane | C8SiOMe | C12SiOMe | C2SiOMe | C18SiOMe |
| Ratio of alkylsilane [mass %] | 7.4 | 7.4 | 33.0 | 7.4 |
| Type of mixed solvent | i-BuOH/i-PrOH | i-BuOH/i-PrOH | i-BuOH/n-PenOH | i-BuOH/i-PrOH |
| (mass ratio) | (80/20) | (80/20) | (80/20) | (80/20) |
| HSP value of mixed solvent | 11.6 | 11.6 | 11.0 | 11.6 |
| Solid content concentration [mass %] | 10 | 10 | 10 | 10 |
| Curing condition | 50° C. 60% RH | 50° C. 60% RH | 50° C. 60% RH | 50° C. 60% RH |
| Evaluation result | | | | |
| Area ratio of region having elastic modulus | 2 | 4 | 31 | 6 |
| of 6 GPa or higher [%] | | | | |
| Area ratio of region having elastic modulus | 79 | 71 | 50 | 43 |
| of 4 Gpa or lower [%] | | | | |
| Root mean square inclination value | 3.7 | 5.1 | 34.2 | 8.3 |
| of surface elastic modulus [Sdq] | | | | |
| Average elastic modulus [GPa] | 2.4 | 3.3 | 5.6 | 4.0 |
| Initial water contact angle [°] | 103 | 102 | 103 | 103 |
| Initial water sliding angle [°] | 7 | 8 | 26 | 8 |
| Water contact angle after abrasion test [°] | 82 | 86 | 95 | 81 |

TABLE 4

| | Example 51 | Example 52 |
|---|---|---|
| Presence/absence of underlayer | Provided | Provided |
| Underlayer forming composition | U1 | U1 |
| Type of tetrafunctional silane | TEOS | TEOS |
| Water-repellent layer forming | T51 | T52 |
| composition | | |
| Type of silicone | 1-1 | 1-1 |
| Ratio of silicone [mass %] | 100.0 | 25.0 |
| Type of alkylsilane | — | C18SiOMe |
| Ratio of alkylsilane [mass %] | 0 | 75.0 |
| Type of mixed solvent | i-BuOH/i-PrOH | i-BuOH/i-PrOH |
| (mass ratio) | (80/20) | (80/20) |
| HSP value of mixed solvent | 11.6 | 11.6 |
| Solid content concentration [mass %] | 10 | 10 |
| Curing condition | 50° C. 60% RH | 50° C. 60% RH |
| Evaluation result | | |
| Area ratio of region having elastic | 0 | 63 |
| modulus of 6 GPa or higher [%] | | |
| Area ratio of region having elastic | 100 | 5 |
| modulus of 4 Gpa or lower [%] | | |
| Root mean square inclination value | 2.1 | 3.4 |
| of surface elastic modulus [Sdq] | | |
| Average elastic modulus [GPa] | 0.7 | 10.2 |
| Initial water contact angle [°] | 103 | 101 |
| Initial water sliding angle [°] | 4 | 32 |
| Water contact angle after abrasion | 53 | 100 |
| test [°] | | |

TABLE 5

| | Example 61 | Example 62 |
|---|---|---|
| Presence/absence of underlayer | Provided | Provided |
| Underlayer forming composition | U1 | U1 |
| Type of tetrafunctional silane | TEOS | TEOS |
| Water-repellent layer forming | T61 | T62 |
| composition | | |
| Type of silicone | 1-1 | 1-1 |
| Ratio of silicone [mass %] | 92.6 | 92.6 |
| Type of alkylsilane | C18SiOMe | C18SiOMe |
| Ratio of alkylsilane [mass %] | 7.4 | 7.4 |
| Type of mixed solvent | AcOBu/i-PrOH | EtOH/ |
| (mass ratio) | (80/20) | i-PrOH(80/20) |
| HSP value of mixed solvent | 9.4 | 12.9 |
| Solid content concentration | 10 | 10 |
| [mass %] | | |
| Curing condition | 50° C. 60% RH | — |
| Evaluation result | | |
| Area ratio of region having elastic | 2 | — |
| modulus of 6 GPa or higher [%] | | |
| Area ratio of region having elastic | 64 | — |
| modulus of 4 Gpa or lower [%] | | |
| Root mean square inclination value | 3.2 | — |
| of surface elastic modulus [Sdq] | | |
| Average elastic modulus [GPa] | 4.5 | — |
| Initial water contact angle [°] | 103 | T62 has poor material |
| Initial water sliding angle [°] | 10 | compatibility, so |
| Water contact angle after | 61 | that no film |
| abrasion test [°] | | can be formed. |

TABLE 6

| | Example 71 | Example 72 |
|---|---|---|
| Presence/absence of underlayer | Provided | Provided |
| Underlayer forming composition | U1 | U1 |
| Type of tetrafunctional silane | TEOS | TEOS |
| Water-repellent layer forming | T71 | T72 |
| composition | | |
| Type of silicone | 1-1 | 1-1 |
| Ratio of silicone [mass %] | 92.6 | 92.6 |
| Type of alkylsilane | C2SiOMe | C6SiOMe |
| Ratio of alkylsilane [mass %] | 7.4 | 7.4 |
| Type of mixed solvent | i-BuOH/i-PrOH | i-BuOH/i-PrOH |
| (mass ratio) | (80/20) | (80/20) |
| HSP value of mixed solvent | 11.6 | 11.6 |
| Solid content concentration [mass %] | 10 | 10 |
| Curing condition | 50° C. 60% RH | 50° C. 60% RH |
| Evaluation result | | |
| Area ratio of region having elastic | 0 | 0 |
| modulus of 6 GPa or higher [%] | | |
| Area ratio of region having elastic | 100 | 98 |
| modulus of 4 Gpa or lower [%] | | |
| Root mean square inclination value | 3.0 | 3.2 |
| of surface elastic modulus [Sdq] | | |
| Average elastic modulus [GPa] | 1.4 | 1.8 |
| Initial water contact angle [°] | 102 | 103 |
| Initial water sliding angle [°] | 8 | 8 |
| Water contact angle after abrasion | 57 | 60 |
| test [°] | | |

### Summary of Results

In each of Examples 1-6, 11-14, and 21-23, an underlayer forming composition containing one or more type(s) of hydrolyzable silicon compounds which may be partially hydrolyzed and condensed between the same species or between different species, selected from the group consisting of Compounds (3) and (4) was prepared. In each of these examples, the following water-repellent layer forming composition was prepared. That is, the water-repellent layer forming composition contains: a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and one or more type(s) of organic solvents; in which an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes, and in which an HSP value of the one or more type(s) of organic solvents is 10.8 to 12.1. In each of these examples, a water-repellent film consisting of a laminated structure of an underlayer and a water-repellent layer was formed by using the above-described underlayer forming composition and the above-described water-repellent layer forming composition.

In Example 31, the following water-repellent layer forming composition was prepared. That is, the water-repellent layer forming composition contains: a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and one or more type(s) of organic solvents; in which an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes, and in which an HSP value of the one or more type(s) of organic solvents is 10.8 to 12.1. In this example, a water-repellent film consisting of a single-layer structure of a water-repellent layer was formed by using the above-described water-repellent layer forming composition.

The surface of the water-repellent layer obtained in each of Examples 1-6, 11-14, 21-23, and 31 had an elastic modulus distribution, and included a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region was 3.5 to 35.0 GPa. The surface of the water-repellent layer obtained in each of these examples had an initial water contact angle of 90° or larger, an initial water sliding angle of 30° or smaller, and maintained a water contact angle of 80° or larger after the abrasion test.

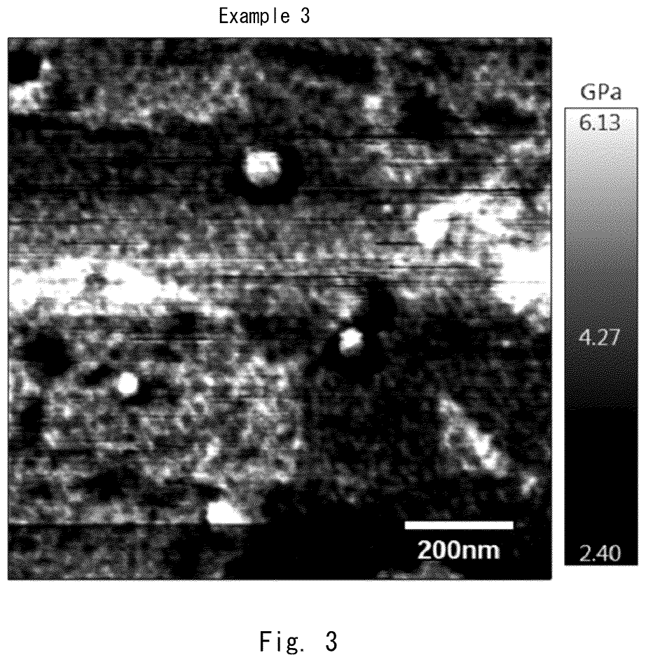

As a representative example, FIG. 3 shows the elastic modulus image in the micron region of the water-repellent layer obtained in Example 3.

In each of these examples, elastic modulus distributions in 10 micron regions in total were evaluated while changing the AFM observation region. In each of these examples, all of arbitrarily selected 10 AFM observation images each having an area of 1 μm square satisfied the above-described regulations. Note that the elastic modulus data shown in the table are data on the AFM observation image that was observed first in each of the examples.

In Example 51, a water-repellent film consisting of a laminated structure of an underlayer and a water-repellent layer was formed in the same manner as in Examples 1 to 6, except that no alkylsilane was used. On the surface of the water-repellent layer obtained in this example, there was no high elastic modulus part having an elastic modulus of 6.0 GPa or higher in an arbitrarily selected micron region of 1 μm square, and the root mean square inclination value of the surface elastic modulus in the micron region was lower than 3.5 GPa. The water contact angle on the surface of the water-repellent layer obtained in this example had significantly decreased after the abrasion test, and the abrasion resistance thereof was poor.

In Example 52, a water-repellent film consisting of a laminated structure of an underlayer and a water-repellent layer was formed by using the same materials as those of Examples 1 to 6. In this example, the amount of one or more type(s) of hydrolyzable alkylsilanes was larger than 50 pts·mass based on 100 pts·mass of the total amount of one or more type(s) of hydrolyzable silicones and the one or more type(s) of hydrolyzable alkylsilanes.

The surface of the water-repellent layer obtained in this example had an elastic modulus distribution, and included a high elastic modulus part having an elastic modulus of 6.0 GPa or higher and a low elastic modulus part having an elastic modulus of 4.0 GPa or lower in an arbitrarily selected micron region of 1 μm square. However, the root mean square inclination value of the surface elastic modulus in the micron region was lower than 3.5 GPa. The initial water sliding angle on the surface of the water-repellent layer obtained in this example was larger than 30°.

In Example 61, a water-repellent film consisting of a laminated structure of an underlayer and a water-repellent layer was formed in the same manner as in Example 3, except that the type of the mixed solvent was changed. The HSP value of the used mixed solvent was lower than 10.8.

The root mean square inclination value of the surface elastic modulus in the micron region on the surface of the water-repellent layer obtained in this example was lower than 3.5 GPa. The water contact angle on the surface of the water-repellent layer obtained in this example had significantly decreased after the abrasion test, and the abrasion resistance thereof was poor.

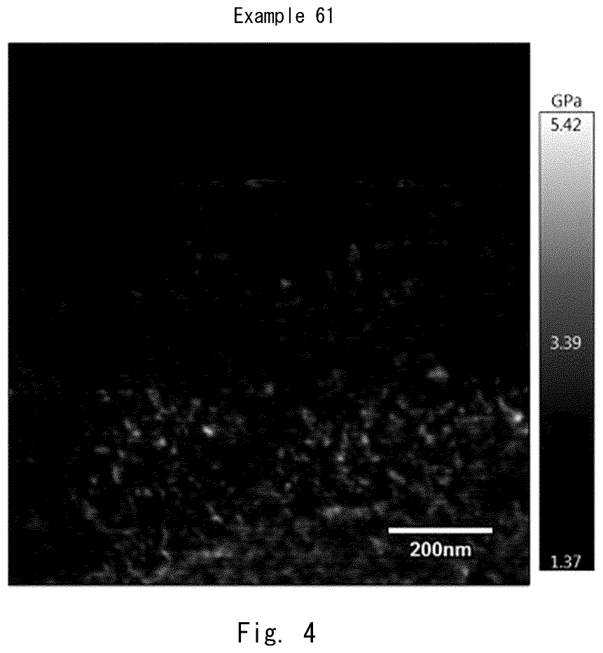

FIG. 4 shows the elastic modulus image of the micron region of the water-repellent layer obtained in Example 61.

In Example 62, a water-repellent film consisting of a laminated structure of an underlayer and a water-repellent layer was formed in the same manner as in Example 3, except that the type of the mixed solvent was changed. The HSP value of the used mixed solvent was higher than 12.1.

In this example, the compatibility of the materials of the water-repellent layer forming composition was poor, so that no water-repellent layer was formed.

In each of Examples 71 and 72, a water-repellent film consisting of a laminated structure of an underlayer and a water-repellent layer was formed in the same manner as in Example 3, except that the type of alkylsilane was changed.

On the surface of the water-repellent layer obtained in each of these examples, there was no high elastic modulus part having an elastic modulus of 6.0 GPa or higher in an arbitrarily selected micron region of 1 μm square, and the root mean square inclination value of the surface elastic modulus in the micron region was lower than 3.5 GPa. The water contact angle on the surface of the water-repellent layer obtained in each of these examples had significantly decreased after the abrasion test, and the abrasion resistance thereof was poor.

The above embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A water-repellent structure comprising a substrate, and a water-repellent film formed on a surface of the substrate, wherein
the water-repellent film comprises a water-repellent layer containing a siloxane bond and one or more type(s) of organic groups bonded to a Si atom and not containing any fluorine atom,
a surface of the water-repellent layer is an outermost surface of the water-repellent film, and
the surface of the water-repellent layer has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region is 3.5 GPa or higher.

2. The water-repellent structure according to claim 1, wherein the root mean square inclination value of the surface elastic modulus in the micron region is 35.0 GPa or lower.

3. The water-repellent structure according to claim 1, wherein the one or more type(s) of organic groups is selected from the group consisting of an alkyl group and an alkylene group.

4. The water-repellent structure according to claim 1, wherein an average elastic modulus in the micron region on the surface of the water-repellent layer is 2.0 to 14.0 GPa.

5. The water-repellent structure according to claim 1, wherein in the micron region on the surface of the water-repellent layer, an area ratio of a high-elastic modulus region having an elastic modulus of 6.0 GPa or higher is 1 to 50%, and an area ratio of a low-elastic modulus region having an elastic modulus of 4.0 GPa or lower is 10 to 80%.

6. The water-repellent structure according to claim 1, wherein an initial water contact angle on the surface of the water-repellent layer is 90° or larger.

7. The water-repellent structure according to claim 1,
wherein the water-repellent layer is a dry-cured substance of a composition containing:
a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and
one or more type(s) of organic solvents;
wherein an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes,
and wherein an HSP value of the one or more type(s) of organic solvents is 10.8 to 12.1, the HSP value being a solubility parameter according to Hansen's definition.

8. The water-repellent structure according to claim 7, wherein
the hydrolyzable silicone is a compound represented by a below-shown Formula (1),
the hydrolyzable alkylsilane is a compound represented by a below-shown Formula (2),
R¹³—(SiR¹²₂O)ₖ₁—SiR¹²₂—Y¹—Si(R¹¹)₃₋ₙ₁(X¹)ₙ₁ (1)
(in the above-shown formula: R¹³ represents an alkyl group having a carbon atom number of 1 to 30; R¹² each independently represents an alkyl group having a carbon atom number of 3 or smaller; Y¹ represents an alkylene group having a carbon atom number of 2 to 4 or an oxygen atom; R¹¹ each independently represents a monovalent hydrocarbon group; X¹ each independently represents a hydrolyzable group; X¹ may be hydrolyzed into a hydroxyl group; k1 is an integer of 10 to 300; and n1 is an integer of 1 to 3), and
R²²—Si(R²¹)₃₋ₙ₂(X²)ₙ₂ (2)
(in the above-shown formula: R²² represents an alkyl group having a carbon atom number of 1 to 30; R²¹ each independently represents a monovalent hydrocarbon group; X² each independently represents a hydrolyzable group; X² may be hydrolyzed into a hydroxyl group; and n2 is an integer of 1 to 3).

9. The water-repellent structure according to claim 1, wherein the water-repellent film includes an underlayer containing a siloxane bond and not containing any fluorine atom below the water-repellent layer.

10. The water-repellent structure according to claim 9, wherein the underlayer is a dry-cured substance of a composition containing one or more type(s) of hydrolyzable silicon compounds which may be partially hydrolyzed and condensed between the same species or between different species, selected from the group consisting of a compound represented by a below-shown Formula (3) and a compound represented by a below-shown Formula (4),
Si(X³)₄ (3)
(in the above-shown formula: X³ each independently represents a hydrolyzable group; and X³ may be hydrolyzed into a hydroxyl group), and
X⁴₃Si—(CH₂)ₘ—SiX⁴₃ (4)
(in the above-shown formula: X⁴ each independently represents a hydrolyzable group; X⁴ may be hydrolyzed into a hydroxyl group; and m is an integer of 1 to 8).

11. The water-repellent structure according to claim 1, wherein the substrate includes a glass plate.

12. A water-repellent layer forming composition containing:
a plurality of types of hydrolyzable silicon compounds which may be partially hydrolyzed and condensed between the same species or between different species and which include one or more type(s) of hydrolyzable silicones containing a hydrolyzable group and one or more type(s) of hydrolyzable alkylsilanes containing a hydrolyzable group and an alkyl group; and
one or more type(s) of organic solvents;
wherein an amount of the one or more type(s) of hydrolyzable alkylsilanes is 1 to 50 pts·mass based on 100 pts·mass of a total amount of the one or more type(s) of hydrolyzable silicones and the one or more type(s) of hydrolyzable alkylsilanes,
and wherein an HSP value of the one or more type(s) of organic solvents is 10.8 to 12.1, the HSP value being a solubility parameter according to Hansen's definition.

13. The water-repellent layer forming composition according to claim 12, wherein
the hydrolyzable silicone is a compound represented by a below-shown Formula (1),
the hydrolyzable alkylsilane is a compound represented by a below-shown Formula (2),
R¹³—(SiR¹²₂O)ₖ₁—SiR¹²₂—Y¹—Si(R¹¹)₃₋ₙ₁(X¹)ₙ₁ (1)
(in the above-shown formula: R¹³ represents an alkyl group having a carbon atom number of 1 to 30; R¹² each independently represents an alkyl group having a carbon atom number of 3 or smaller; Y¹ represents an alkylene group having a carbon atom number of 2 to 4 or an oxygen atom; R¹¹ each independently represents a monovalent hydrocarbon group; X¹ each independently represents a hydrolyzable group; X¹ may be hydrolyzed into a hydroxyl group; k1 is an integer of 10 to 300; and n1 is an integer of 1 to 3), and
R²²—Si(R²¹)₃₋ₙ₂(X²)ₙ₂ (2)
(in the above-shown formula: R²² represents an alkyl group having a carbon atom number of 1 to 30; R²¹ each independently represents a monovalent hydrocarbon group; X² each independently represents a hydrolyzable group; X² may be hydrolyzed into a hydroxyl group; and n2 is an integer of 1 to 3).

14. The water-repellent layer forming composition according to claim 12, wherein the surface has an elastic modulus distribution, and includes a high elastic modulus part having an elastic modulus of 6.0 GPa or higher and a low elastic modulus part having an elastic modulus of 4.0 GPa or lower in an arbitrarily selected micron region of 1 μm square; and a root mean square inclination value of a surface elastic modulus in the micron region is 3.5 GPa or higher.
